(19) United States
(12) Patent Application Publication
(10) Pub. No.: US 2014/0352557 A1
(43) Pub. Date: Dec. 4, 2014

(54) APPARATUS FOR COMPACTING AND COMBINING PRODUCT INTO A SINGLE COMPACTED DISC

(71) Applicant: Lloyd C. Linton, Rockford, OH (US)

(72) Inventor: Lloyd C. Linton, Rockford, OH (US)

(21) Appl. No.: 14/295,027

(22) Filed: Jun. 3, 2014

Related U.S. Application Data
(60) Provisional application No. 61/830,332, filed on Jun. 3, 2013.

(51) Int. Cl. B30B 9/32; B30B 11/00; B30B 1/00

(52) U.S. Cl. CPC B30B 9/326; B30B 9/327; B30B 1/00; B30B 11/007
USPC 100/96; 100/189; 100/207

(57) ABSTRACT

An apparatus allows various loose product, such as tire wire, cans, rubber, scrap metal, and the like, to be fed to provide a single, compacted disc output. The apparatus includes a shoot for feeding product where a first hydraulic cylinder can push the fed product into a main tube. A concave pushing surface can help shape the product into a cylinder. A second hydraulic ram can push product as it is gathered and intertwined within the main tube. The second hydraulic ram typically operates orthogonal to the first hydraulic cylinder. The resulting product is intertwined into a disc shape that is generally sufficiently meshed together to prevent the disc from falling apart, easing storage and transport of the product. This is especially useful for product that is difficult to mesh together, such as tire wire, for example.

### CROSS-REFERENCE TO RELATED APPLICATIONS

This application claims the benefit of U.S. provisional patent application No. 61/830,332, filed Jun. 3, 2013, the contents of which are herein incorporated by reference.

### BACKGROUND OF THE INVENTION

The present invention relates to material handling machines and, more particularly, to an apparatus for compacting and combining a variety of loose product into a single compacted disc.

When handling various products, such as tire wire, it can be difficult to handle such product. Tire wire can be difficult to handle and store. Similar issues are present with the handling and storing of other types of products, such as rubber, aluminum cans, scrap metal, and the like, as well.

As can be seen, there is a need for an apparatus that can compact various loose product into a single compacted disc.

### SUMMARY OF THE INVENTION

In one aspect of the present invention, a apparatus for compacting loose material into a single, compacted output product comprises a product feed shoot for receiving the loose material; a first ram member movable into the product feed shoot to push the loose material; a main tube; an opening in the main tube receiving the first ram member therein, wherein the loose material pushed by the first ram member is guided into the main tube by movement of the first ram member through the product feed shoot and into the opening in the main tube; a door covering a first open end of the main tube; and a second ram member movable into a second open end of the main tube.

In another aspect of the present invention, a apparatus for compacting loose material into a single, compacted output product comprises a product feed shoot for receiving the loose material; a first ram member having a concave shaped end, the first ram member movable into the product feed shoot to push the loose material; a main tube formed as a cylindrical tubular member; an opening in the main tube receiving the first ram member therein, wherein the loose material pushed by the first ram member is guided into the main tube by movement of the first ram member through the product feed shoot and into the opening in the main tube; a door covering a first open end of the main tube; and a second ram member movable into a second open end of the main tube, wherein the concave end shape of the first ram member completes a cylindrical inner shape of the main tube when the first ram member is disposed in the opening.

These and other features, aspects and advantages of the present invention will become better understood with reference to the following drawings, description and claims.

### BRIEF DESCRIPTION OF THE DRAWINGS

FIG. 1 is a perspective view of a compacting apparatus according to an exemplary embodiment of the present invention;

FIG. 2 is a top view of the apparatus of FIG. 1;

FIG. 3 is a front view of the apparatus of FIG. 1;

FIG. 4 is a side view of the apparatus of FIG. 1;

FIG. 5 is a cross sectional view taken along line A-A of FIG. 1;

FIG. 6 is a cross sectional view taken along line B-B of FIG. 1;

FIG. 7 is a cross sectional view taken along line C-C of FIG. 1;

FIG. 8 is a perspective view of the main tube portion of the apparatus of FIG. 1;

FIG. 9 is a perspective view of a support structure for a first hydraulic cylinder of the apparatus of FIG. 1;

FIG. 10 is a perspective view of a door of the apparatus of FIG. 1;

FIG. 11 is a perspective view of a first hydraulic ram member of the apparatus of FIG. 1;

FIG. 12 is a side view of the first hydraulic ram member of FIG. 11;

FIG. 13 is a perspective view of a loose product feeding shoot of the apparatus of FIG. 1;

FIG. 14 is a perspective view of the main tube of the apparatus of FIG. 1;

FIG. 15 is a perspective view of a main ram of the apparatus of FIG. 1;

FIG. 16 is a side view of the main ram of FIG. 15;

FIG. 17 is a cross sectional view of the main ram of FIG. 15;

FIG. 18 is a side view of the apparatus of FIG. 1 with an optional conveyor and grinder feeding the product feeding shoot;

FIG. 19 is a front view of the apparatus of FIG. 1 with the optional conveyor and grinder of FIG. 18;

FIG. 20 is a photo of one example of the output product disc of the apparatus of FIG. 1;

FIG. 21 is another photo of an example of the output product disc of the apparatus of FIG. 1; and

FIG. 22 is a photo of an example of the output product disc of the apparatus of FIG. 1, illustrating a hollow inner portion thereof.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an apparatus that various loose product, such as tire wire, cans, rubber, scrap metal, and the like, can be fed to provide a single, compacted disc output. The apparatus includes a shoot for feeding product where a first hydraulic cylinder can push the fed product into a main tube. A concave pushing surface can help shape the product into a cylinder. A second hydraulic ram can push product as it is gathered and intertwined within the main tube. The second hydraulic ram typically operates orthogonal to the first hydraulic cylinder. The resulting product is intertwined into a disc shape that is generally sufficiently meshed together to prevent the disc from falling apart, easing storage and transport of the product. This is especially useful for product that is difficult to mesh together, such as tire wire, for example. The present invention can also blend together materials, such as tire wire and scrap metal, for example.

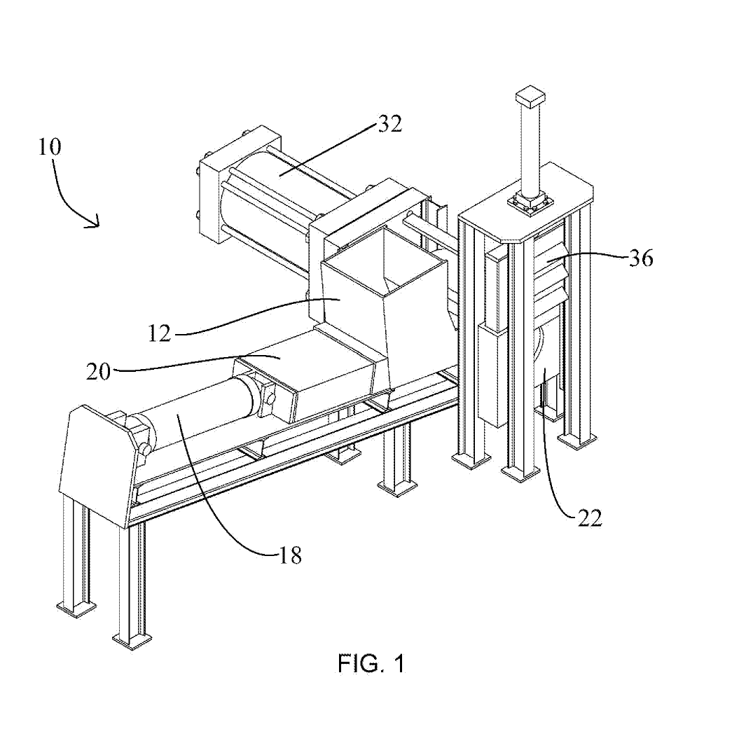

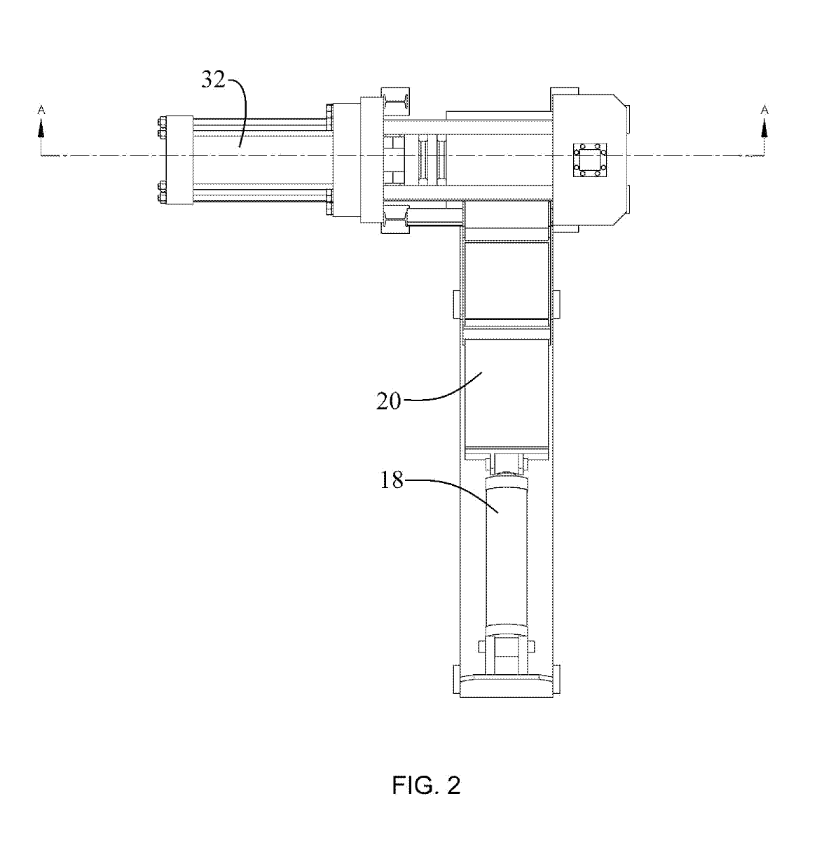

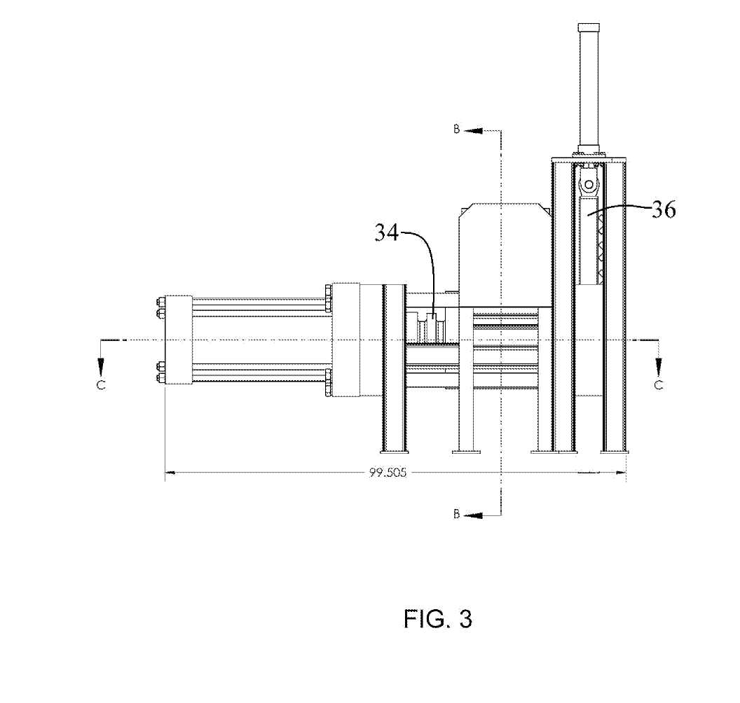

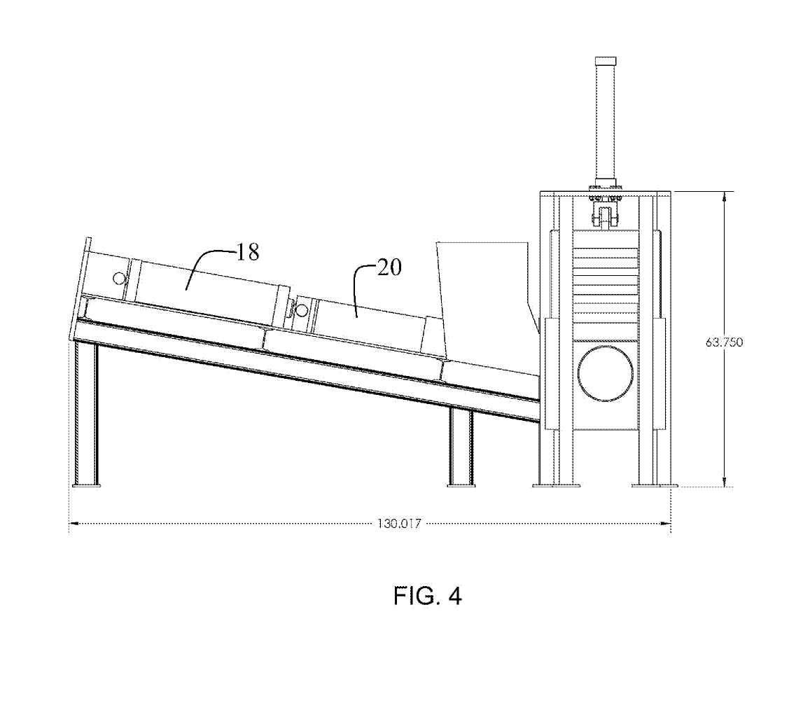

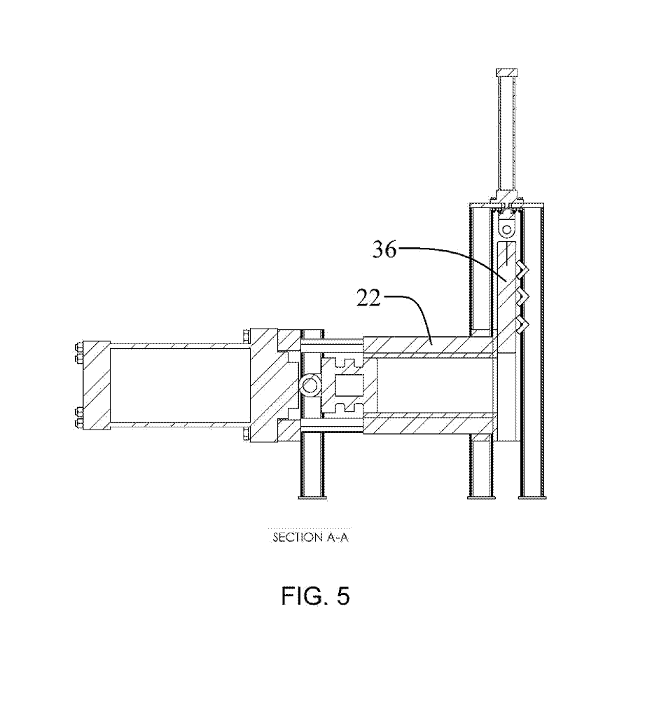

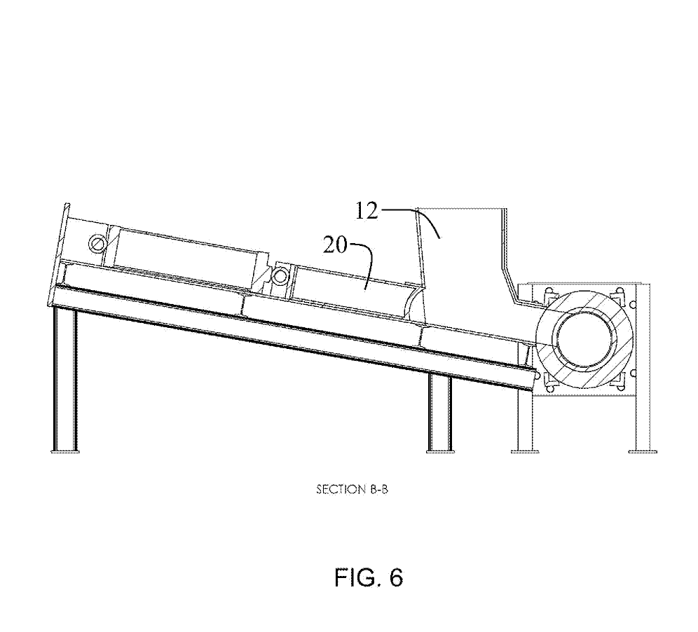

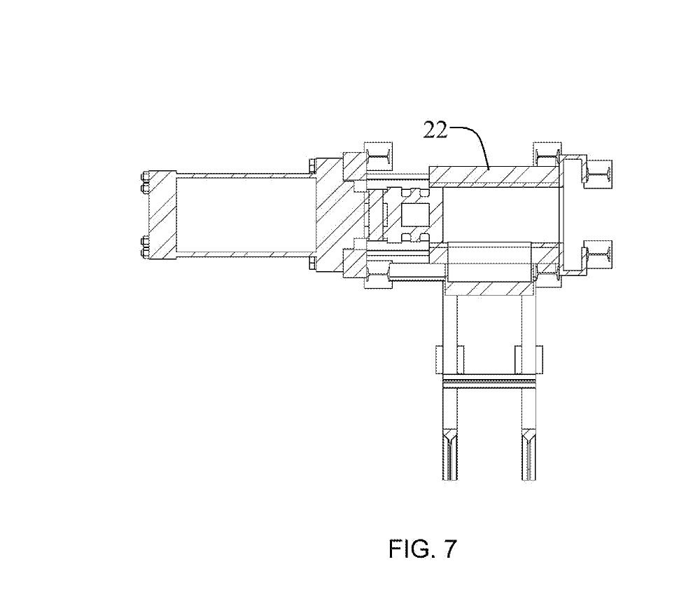

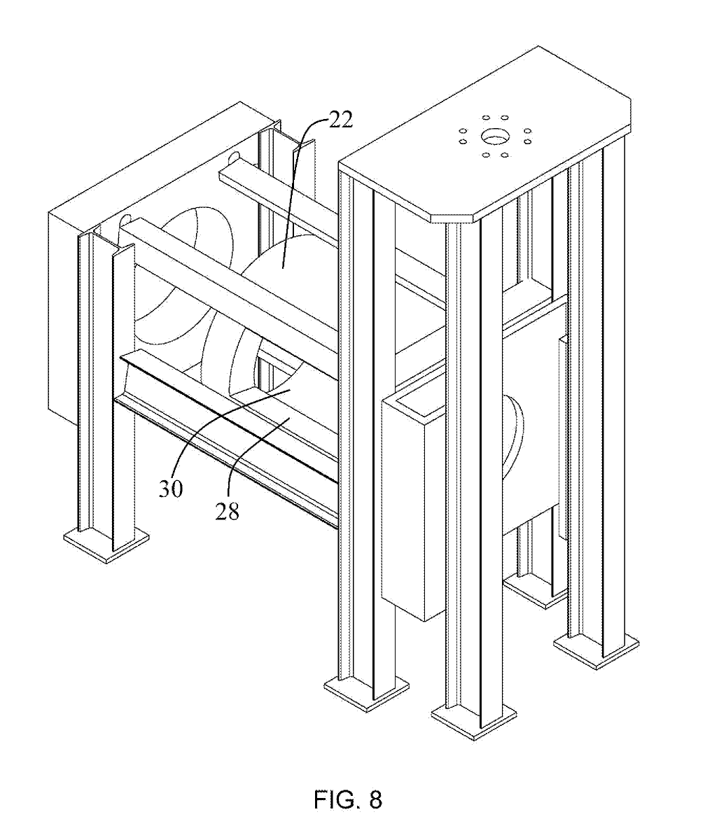

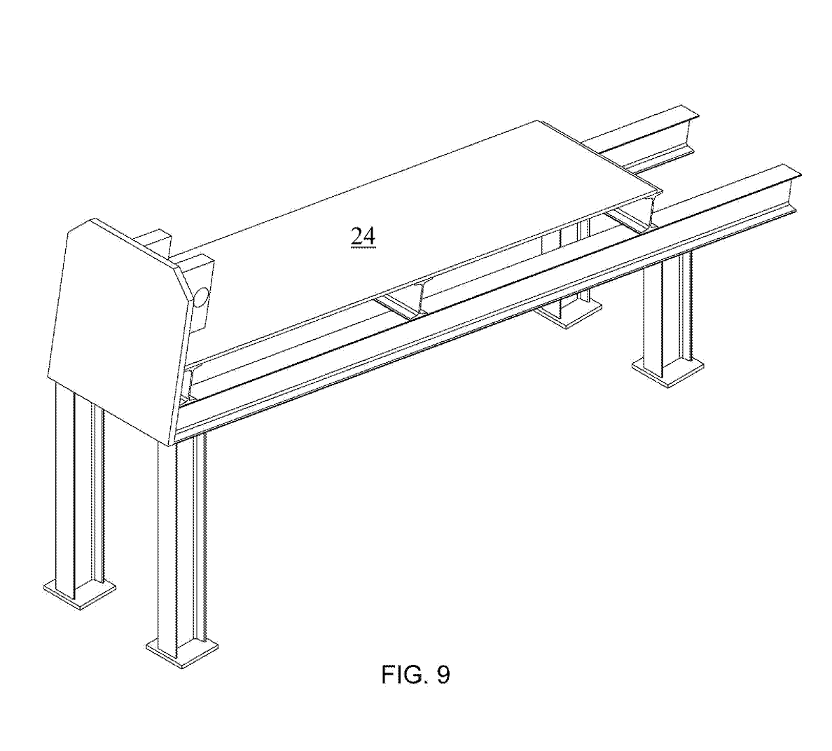

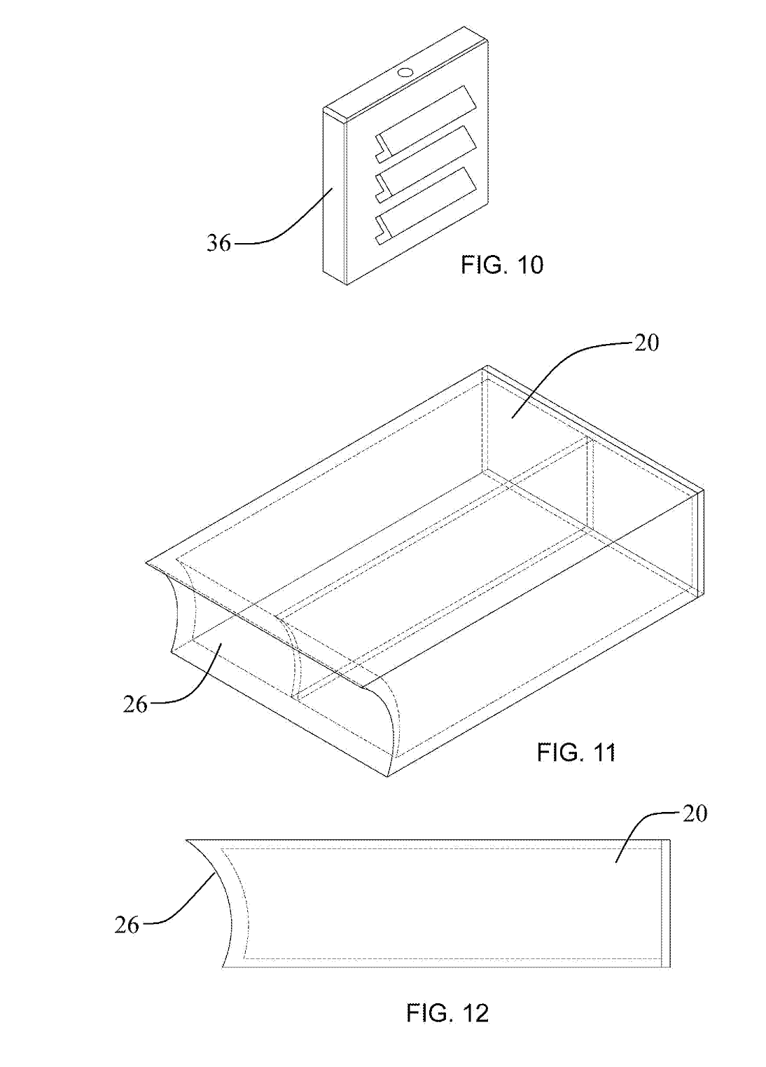

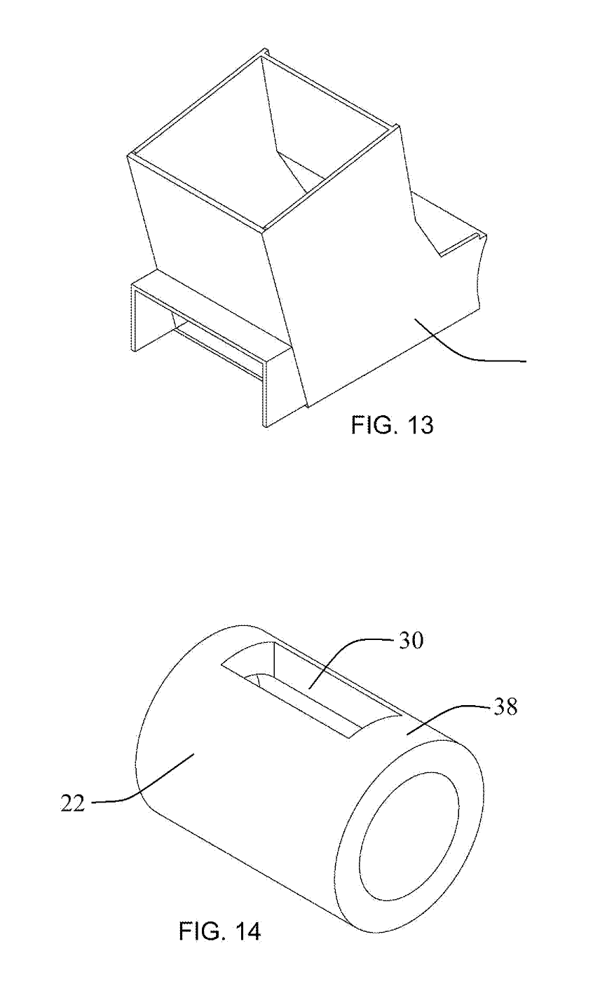

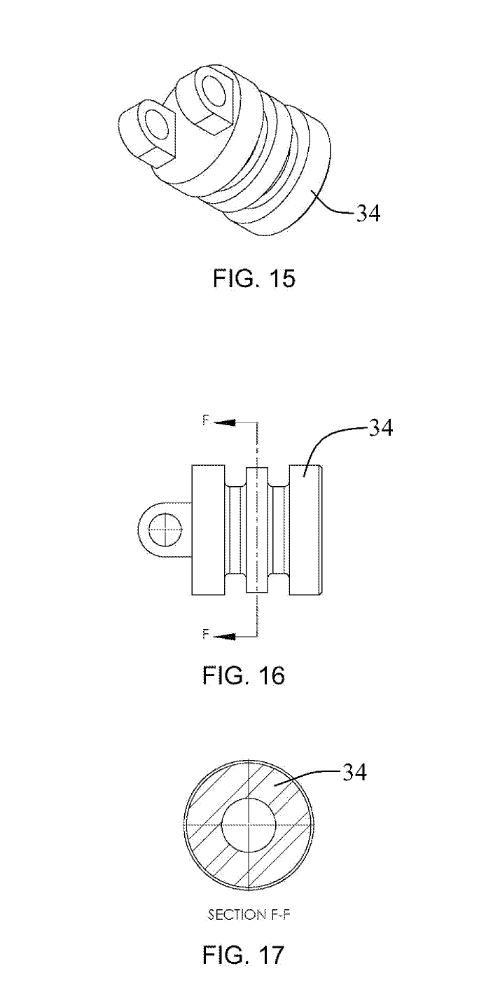

Referring now to FIGS. 1 through 17, loose product (not shown) can be fed into a product loading shoot 12 of the compacting apparatus 10. The product can be fed continually or in a batch, or piece-by-piece process, for example.

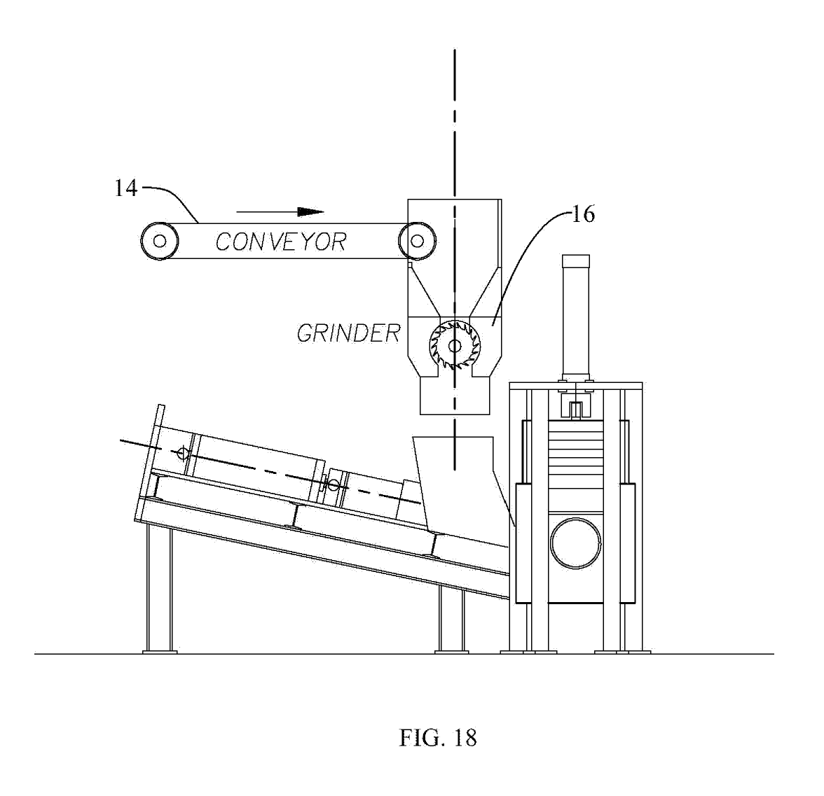

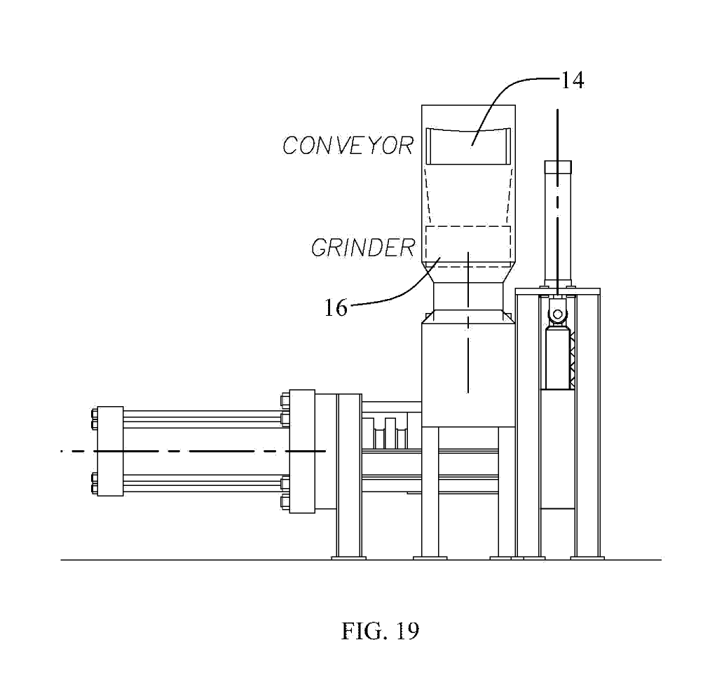

In some embodiments, as shown in FIGS. 18 and 19, a conveyor 14 can carry product to a grinder 16 located above the product loading shoot 12. The grinder 16 may be used to create a finer sized product prior to processing. The grinder 16 may shred or slice the product, for example. The conveyor 14 may be optional and product may be gravity fed into the grinder 16. In some embodiments, the grinder 16 may be optional and the conveyor 14 (or simply a gravity fed hopper, not shown) can feed the product directly to the product loading shoot 12.

A first hydraulic cylinder 18, attached to a support structure 24, can push a first ram member 20, which, in turn, can push the product into a main tube 22. The first hydraulic cylinder ram member 20 can have a concave product contacting surface 26 to help roll and move the product as it is moved into the main tube 22. A lip 28 on the main tube 22 can help flow the product therein. The concave product contacting surface 26 meets the main tube 22 to fill the hole 30 in the main tube 22. Typically, the concave product contacting surface 26 completes the interior of the main tube 22 into a smooth, spherical inner surface.

After the product passes the lip 28 into the main tube 22, the product will turn, twist and press into each other. When in the main tube 22, a second hydraulic cylinder 32 with a second ram member 34 will turn, twist and press the product into each other. At the end of the final press inside the main tube 22, the second hydraulic cylinder ram member 34 can press the product into a single, compacted piece. A door 36 can open and the disc can be expelled from the apparatus 10.

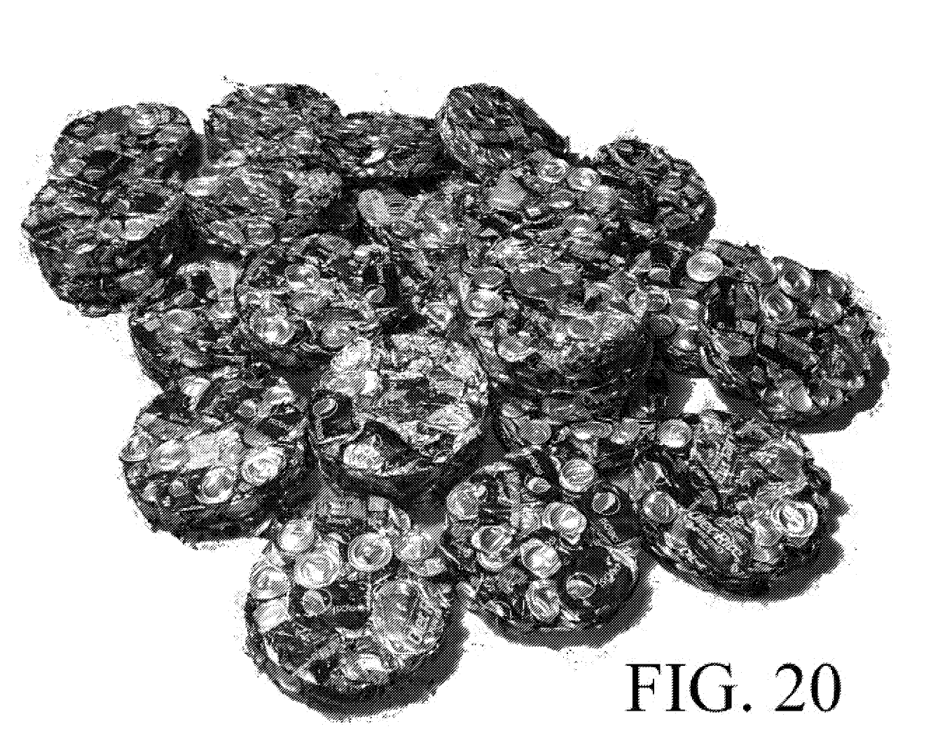

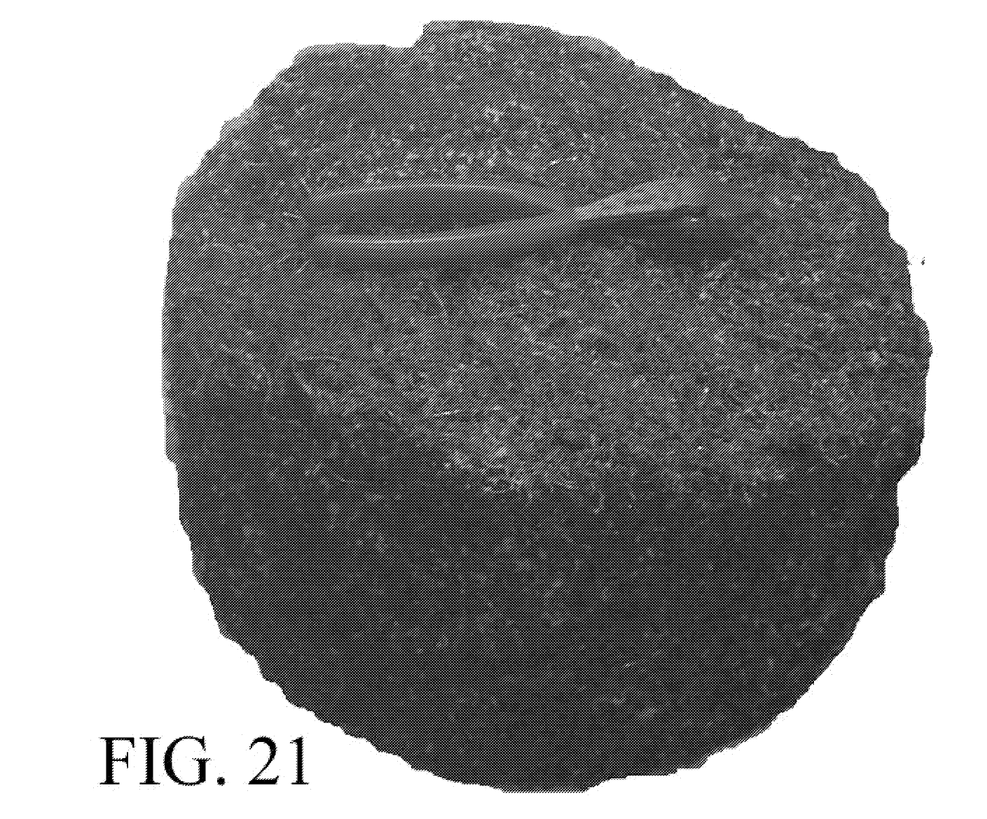

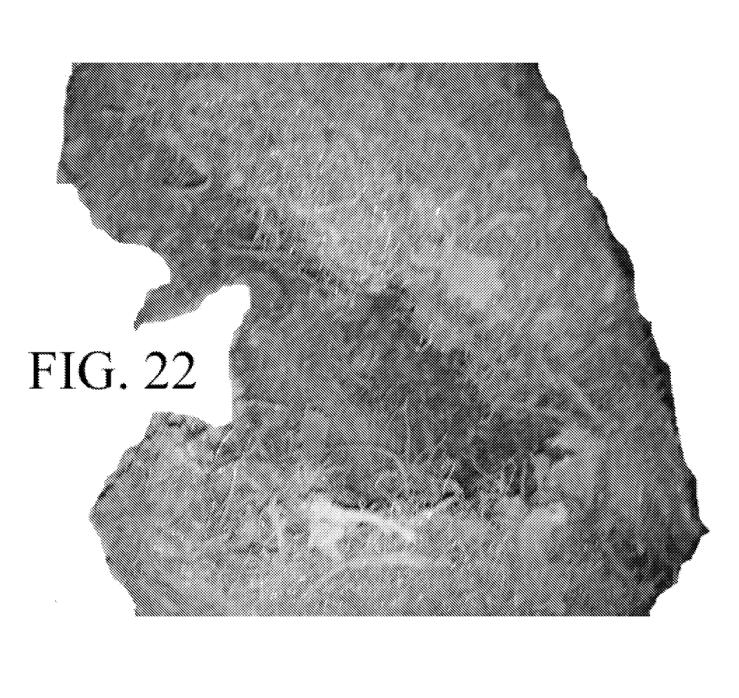

The output (as shown in FIGS. 20 and 21, as examples) can take the shape of the cross-section of the main tube, typically round. In some embodiments, the cross-section of the main tube can be other shapes, such as square or rectangular, where cubic output product is produced. Due to the twisting and turning of the product, the intermediate product in the main tube is often formed with a hollow interior portion as shown in FIG. 22, for example. A final high pressure compression of this intermediate product creates a solid compressed product with little chance of coming apart. The last section 38, such as the last six inches of the main tube 22 is solid for use in this final high pressure compression.

The apparatus of the present invention can be made from materials suitable for the intended purpose. Similarly, the hydraulic cylinders can be designed to provide the appropriate force to twist, turn and press the product into the desired output. The size of the first and second hydraulic cylinder rams can vary, depending on the material. While some of the Figures show dimensions, these are merely exemplary dimensions that can vary within the scope of the present invention.

The apparatus of the present invention can be used for various materials, such as various types of wire, cans, various loose material, dirt, scrap metal, plastic, rubber, other metal products, wood products and chips, and the like.

It should be understood, of course, that the foregoing relates to exemplary embodiments of the invention and that modifications may be made without departing from the spirit and scope of the invention as set forth in the following claims.

What is claimed is:

1. An apparatus for compacting loose material into a single, compacted output product, comprising:
a product feed shoot for receiving the loose material;
a first ram member movable into the product feed shoot to push the loose material;
a main tube;
an opening in the main tube receiving the first ram member therein, wherein the loose material pushed by the first ram member is guided into the main tube by movement of the first ram member through the product feed shoot and into the opening in the main tube;
a door covering a first open end of the main tube; and
a second ram member movable into a second open end of the main tube.

2. The apparatus of claim 1, wherein the first ram member has a concave end shape.

3. The apparatus of claim 2, wherein the concave end shape of the first ram member completes a cylindrical inner shape of the main tube when the first ram member is disposed in the opening.

4. The apparatus of claim 1, wherein the first ram member is driven by a first hydraulic cylinder.

5. The apparatus of claim 1, wherein the second ram member is driven by a second hydraulic cylinder.

6. The apparatus of claim 1, wherein the second open end, when the door is in place thereover, is a solid cylindrical shape.

7. The apparatus of claim 1, wherein the door is movable to an open position to release a compacted output product from the first end of the main tube.

8. The apparatus of claim 1, wherein the main tube is formed as an open cylinder.

9. The apparatus of claim 1, further comprising a conveyor carrying the loose material to the product feed shoot.

10. The apparatus of claim 1, further comprising a grinder operable to grind the loose material prior to delivery to the product feed shoot.

11. An apparatus for compacting loose material into a single, compacted output product, comprising:
a product feed shoot for receiving the loose material;
a first ram member having a concave shaped end, the first ram member movable into the product feed shoot to push the loose material;
a main tube formed as a cylindrical tubular member;
an opening in the main tube receiving the first ram member therein, wherein the loose material pushed by the first ram member is guided into the main tube by movement of the first ram member through the product feed shoot and into the opening in the main tube;
a door covering a first open end of the main tube; and
a second ram member movable into a second open end of the main tube, wherein
the concave end shape of the first ram member completes a cylindrical inner shape of the main tube when the first ram member is disposed in the opening.

12. The apparatus of claim 11, wherein the first ram member is driven by a first hydraulic cylinder.

13. The apparatus of claim 11, wherein the second ram member is driven by a second hydraulic cylinder.

14. The apparatus of claim 11, wherein the second open end, when the door is in place thereover, is a solid cylindrical shape.

15. The apparatus of claim 11, wherein the door is movable to an open position to release a compacted output product from the first end of the main tube.
